(19) United States
(12) Patent Application Publication
(10) Pub. No.: US 2024/0264580 A1
(43) Pub. Date: Aug. 8, 2024

(54) PARAMETRIC AND AUTOMATED TOOL FOR THE DESIGN OF STEEL SUBSTRUCTURE OF COMPOSITE MOLDS

(71) Applicant: TPI Technology, Inc., Scottsdale, AZ (US)

(72) Inventor: Thore Braren, Berlin (DE)

(21) Appl. No.: 18/431,448

(22) Filed: Feb. 2, 2024

Related U.S. Application Data
(60) Provisional application No. 63/482,833, filed on Feb. 2, 2023.

(51) Int. Cl. G05B 19/4155

(52) U.S. Cl. CPC G05B 19/4155; G05B 2219/35005

(57) ABSTRACT

A method for manufacturing a metal frame support of a wind turbine blade mold includes receiving a wind turbine blade mold surface including a three-dimensional geometry file. The method includes receiving at least one input parameter and receiving a design scheme. The method includes outputting a first plurality of files including at least one line model wherein the line model represents a generated framework. The method includes outputting a second plurality of files comprising at least one element of geometry data which can be edited and refined. The method includes performing finite element analysis of the line model and at least one element of geometry data—thus, optimization of the substructure can be done while the design phase is not yet concluded. The method includes outputting a full frame model and outputting at least one technical drawing of the full frame model.

### CROSS-REFERENCE TO RELATED APPLICATIONS

This application claims the benefit of priority under 35 USC 119 to U.S. Provisional Application No. 63/482,833 filed Feb. 2, 2023, the entire contents of which are hereby incorporated by reference.

### BACKGROUND OF THE DISCLOSED SUBJECT MATTER

### Field of the Disclosed Subject Matter

The disclosed subject matter relates to a system for metal frame generation (e.g. geometry, strut location/geometry/size/etc., load distribution, etc.). Particularly, the present disclosed subject matter is directed to automated metal frame generation by one or more computer programs for the support structure of a Fiber Reinforced Plastic molds, such as wind turbine blades.

### Description of Related Art

Fiber Reinforced Plastic (FRP) parts, e.g. for composite structures such as wind turbines, automotive and marine vehicles, etc., are mainly produced in molds with a complex surface geometry. To ensure the integrity of the mold shape the mold surface is supported by a metal substructure. The mold substructure is carrying the weight of the mold surface, the FRP part and manufacturing tools such as jigs and fixtures which are needed to produce the FRP part. During the whole manufacturing process the integrity of the mold surface shape needs to be ensured. The mold substructure is mainly a framework made of tubular metal profiles which will be connected to the mold surface.

More and more industry sectors rely on parts made of FRP. In the sectors of aircraft and wind power the FRP parts are getting larger and more complex which results in larger and more complex molds. Because of larger and more complex molds the design of the substructure of these is getting more complicated and time consuming.

There thus remains a need for an efficient and economic method and system for algorithms to automate the design of mold-supporting substructures or “bases” by modern computer technology. The following text describes a parametric and automated software tool for the design of metal substructures of molds for FRP parts.

### SUMMARY OF THE DISCLOSED SUBJECT MATTER

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

During the design of metal substructures of molds for fiber reinforced plastic (FRP) parts a significant amount of repetitive manual work is needed. This is because most of the molds have a complex geometry, and the designer needs to do the sub structure design step by step by hand but is following a strict repetitive workflow. Every part of the tubular structure needs to be added manually to the 3D model. Additionally, the preparation of the manufacturing drawings needs to be done by hand which takes a significant amount of time and is not standardized. Afterwards structural analysis of the framework is needed to check its integrity, a process that requires applying several load cases.

To help the design engineer, the draftsman, or any other users, the following described software tool was developed. The design engineer provides a list of input parameters and the complex mold surface geometry (3D CAD data) for the mold frame generator (MFG). The tool automatically creates two 3D models and manufacturing drawings of the substructure according to the input parameter and the mold surface geometry provided.

One of the two 3D models is a line model of the mold frame and can be used for finite element analyses. This option is creating an easy opportunity for the integration of structural analysis in the design process; thus, optimization of the substructure can be done while the design phase is not yet concluded. The second 3D model is a solid body 3D model which can be edited and refined. In various embodiments, one or more findings from the second 3D model may be fed into a first 3D model on one or more subsequent runs. This model will be used by the program to create the manufacturing drawings.

A resolution of this trend is to use algorithms to automate the design by modern computer technology. The following text describes a parametric and automated software tool for the design of metal substructures of molds for FRP parts.

To achieve these and other advantages and in accordance with the purpose of the disclosed subject matter, as embodied and broadly described, the disclosed subject matter includes a method for manufacturing a metal frame support of a wind turbine blade mold. The method includes receiving a wind turbine blade mold surface including a three-dimensional geometry file. The method includes receiving at least one input parameter and receiving a design scheme. The method includes outputting a first plurality of files including at least one line model wherein the line model represents a generated framework. The method includes outputting a second plurality of files comprising at least one element of geometry data in text form. The method includes performing finite element analysis of the line model and at least one element of geometry data. The method includes outputting a full frame model and outputting at least one technical drawing of the full frame model.

The at least one input parameter includes one of mold shell thickness, distance from the mold surface to a ground level, and structural tubing. The design scheme is scaled automatedly to the at least one input parameter and the mold surface. The design scheme comprises a cross section of a metal frame. The design scheme includes an adjacent side connection and a bottom connection. The design scheme is selected from a plurality of design schemes. The design scheme includes an adjacent side connection and a bottom connection. The second plurality of files includes at least one element of data representing lines, start points, end points, and orientation of a portion of the metal frame. The method further includes performing quality control with the at least one input parameter, and/or converting the mold surface to a point cloud. The point cloud includes 100 points per 100 millimeters.

To achieve these and other advantages and in accordance with the purpose of the disclosed subject matter, as embodied and broadly described, the disclosed subject matter includes a system for manufacturing a metal frame support of a wind turbine blade mold. The system includes a first module for receiving input data including at least a wind turbine blade mold surface including a three-dimensional geometry file, at least one input parameter, and a design scheme. The system includes a second module for generating a first plurality of files comprising at least one line model wherein the line model represents a generated framework and a second plurality of files comprising at least one element of geometry data in text form. The system includes a third module for performing finite element analysis of the line model and at least one element of geometry data, outputting a full frame model, and outputting at least one technical drawing of the full frame model.

The at least one input parameter includes one of mold shell thickness, distance from the mold surface to a ground level, and structural tubing. The design scheme is scaled automatically to the at least one input parameter and the mold surface. The design scheme includes a cross section of a metal frame. The design scheme includes an adjacent side connection and a bottom connection. The design scheme is selected from a plurality of design schemes. The second plurality of files comprises at least one element of data representing lines, start points, end points, and orientation of a portion of the metal frame. Quality control is performed with the at least one input parameter. The mold surface to a point cloud. The point cloud comprises 100 points per 100 millimeters.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more embodiment(s) or example(s) of the present subject matter in whole or in part.

FIG. 1 is a schematic representation of the method for metal frame generation in accordance with the disclosed subject matter.

FIGS. 2A-2C are schematic views of a framework associated with 3D and geometry files that they are output to according to the method shown in FIG. 1.

FIGS. 2D-2H are schematic views of various schemes according to the method shown in FIG. 1.

FIG. 3 is a view of 3D geometry associated with a FRP mold in accordance with the disclosed subject matter.

FIG. 4 is a view of 3D geometry representing the metal frame in the design process in accordance with the disclosed subject matter.

FIG. 5 is a view of a technical drawing associated with the generated metal frame in accordance with the disclosed subject matter.

FIG. 6 is a cloud computing node according to an embodiment of the present disclosure.

### DETAILED DESCRIPTION OF AN EXEMPLARY EMBODIMENT

Reference will now be made in detail to exemplary embodiments of the disclosed subject matter, an example of which is illustrated in the accompanying drawings. The method and corresponding steps of the disclosed subject matter will be described in conjunction with the detailed description of the system.

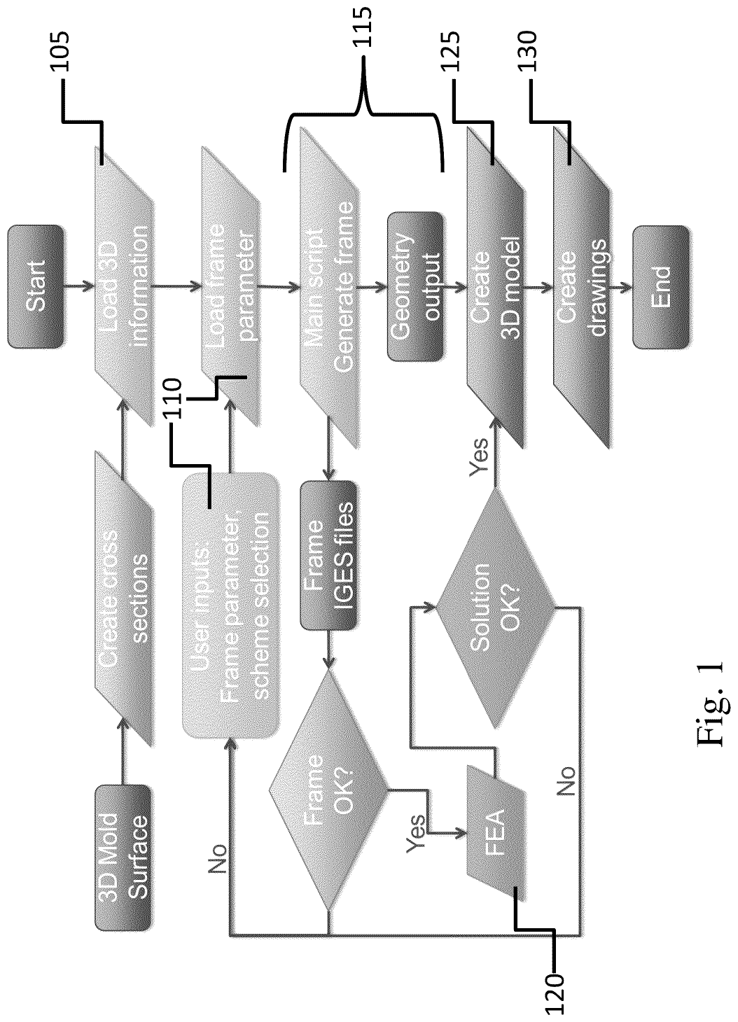

The methods and systems presented herein may be used for metal frame generation. The disclosed subject matter is particularly suited for the automated generation of metal frames for support structure of FRP molds. For purpose of explanation and illustration, and not limitation, an exemplary embodiment of the system in accordance with the disclosed subject matter is shown in FIG. 1 and is designated generally by reference character 100. Similar reference numerals (differentiated by the leading numeral) may be provided among the various views and Figures presented herein to denote functionally corresponding, but not necessarily identical structures.

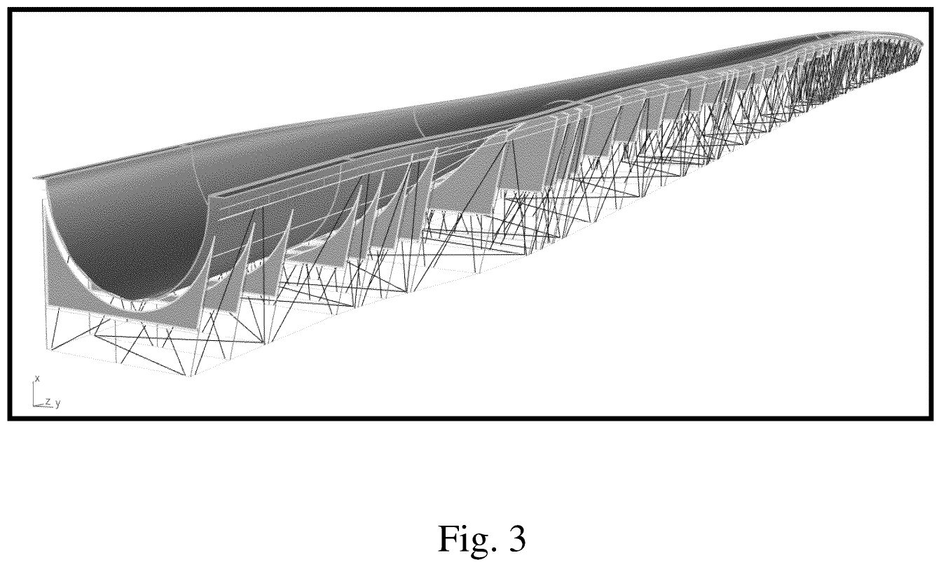

As shown in FIG. 1, method 100 includes, at step 105, receiving a mold surface comprising a three-dimensional geometry file. For example the mold surface can include the design specifications of a wind turbine blade include span, root vs. tip contouring, camber and chord lengths, weight, etc. The mold surface may be one or more mold surfaces configured to shape an FRP part such as FIG. 3. The mold surface may include more than one mold surface configured to mate together to form a whole FRP part. The geometry file may be uploaded to one or more computers, computer programs, servers, or the like. The geometry file may be a 3D Computer Aided Design (CAD) or Computer Aided Manufacturing (CAM) file native to one or more CAD/CAM programs. The geometry file may be downloaded from the internet or one or more other locations. The geometry file may be generated by the one or more computers, servers, or computer programs this method is executed on. The geometry file may be one or more two-dimensional representations that are electronically manipulated to form a three-dimensional representation of the mold surface.

With continued reference to FIG. 1, step 105 may also include the automated creation of one or more cross sections, at varying locations along the blade (and thus mold, and underlying base or substructure) from the input 3D geometry file. The 3D geometry file may include information associated with cross sections thereof, or they may be generated by one or more computing systems.

As shown in FIG. 1, method 100 includes converting the mold surface to a point cloud. The point cloud includes 100 points per 100 millimeters. In some embodiments, select regions of the FRP can have a greater concentration points (e.g. the root of a blade can have a greater density of points than a tip portion). For the purposes of this disclosure, “point cloud” is one or more electronic representations of geometry (blade, mold and/or base substructure) including a plurality of points all sharing a common coordinate system in which the points represent elements of an overall geometry. For example and without limitation, the point cloud may include points that represent a straight line or edge of a part. For example and without limitation, the point cloud may include points that represent the corners or vertices of a part. For example and without limitation, the point cloud may include points that represent the outer mold line of a part or the internal geometry of a part such as hollows, internal corners and/or cavities, shear web location (as well as geometry), core panels within the blade, etc. The point cloud may include one or more levels of granularity. For example and without limitation, the point cloud may include a greater or lesser number of points per a length. For example and without limitation, the point cloud may include 10 points per 100 mm. For example and without limitation, the point cloud may include 1000 points per 10 mm according to an embodiment of the method. The point cloud may include or alternatively or additionally used with a mesh overlaid thereon. The mesh may be generated by one or more meshing tools utilized one or more mesh algorithms, methodologies, and/or processes.

As shown in FIG. 1, the method 100 includes, at step 110, receiving at least one input parameter. The at least one input parameter may be one or more desired criteria of a metal frame by a user, who may be one or more designers (e.g. strut dimensions, locations, center of gravity, global coordinates, etc.). The at least one input parameter may include, parameters associated with a mold (e.g., mold shell type, mold position, and/or parameters calculated thereof). The at least one input parameter may include, parameters associated with a frame (e.g., a metal frame), such as floor level, segment distance, flange dimensions, and/or parameters calculated thereof. The at least one input parameter may include, parameters associated with a hinge, such as hinge type, high position, hinge dimensions, and/or parameters calculated thereof. The at least one input parameter may include, parameters associated with a box, such as a box size, and/or parameters calculated thereof. The at least one input parameter may include, parameters associated with a frame shell attachment, such as spreader rule, spreader dimensions, spreader distance, web dimensions, and/or parameters calculated thereof. The at least one input parameter may include, parameters associated with beams, such as bracing dimensions, runner dimensions, stringer dimensions, and/or other suitable parameters. The at least one parameter may include, suitable parameters associated with any components of the systems as described herein. For example and without limitation, the at least one input parameter may include, mold shell thickness, type of mold such as hinged clamshell, hinge locations and dimensions, tapers of one or more surfaces, range of motion of mold (if applicable based on mold type), distance from the mold surface to a ground level, and/or structural tubing. The at least one input parameter may include materials, structural steel such as box steel, circular tubing selection. The at least one input parameter can be provided by a list or can be entered into a graphical user interface (GUI). The at least an input parameter may be selected from a list by clicking a box, radio button, or another method of selection on a computer, tablet, or a smartphone. The at least an input parameter may include automatedly generated input parameters associated with one or more 3D geometries previously uploaded by a user or received by the computing system. The at least one input parameter may be generated according to one or more mold surfaces received. The at least one input parameter may be received as a portion of the received 3D geometry from step 105 such as properties drafted into the CAD/CAM file.

In one exemplary method, all input parameters are initially generated in a file (e.g., an Excel file) and provided to a user as an example guideline. The user can use the guideline for selecting one or more of the input parameters. For example, according to the example guideline and the experience of the user, the user can generate a first approximation with the automated tool as described herein. The tool then generates a line model (e.g., as shown in FIG. 3), from which the user can make a manual visual plausibility check (e.g., at the step of “Frame OK?” in FIG. 1). If the results are not desired, the user can change the parameters in the file (e.g., according to the user's findings) until the results are satisfactory. Then, an finite element analysis (FEA) is conducted by a manual process. According to the results from the FEA, the user can check if the generated model fulfills the requirements such as weight restrictions, deflection, and/or safety factors. In various embodiments, these requirements can be defined by a customer, a supplier or by a standard (e.g., government standards). If one or more of the requirements is not fulfilled, the user can change the input parameters. For example and without limitation, if there is a safety factor that does not meet a standard, the user can strengthen the frame in this region by changing the scheme, adding an additional cross section in this region, and/or using stronger steel tubes.

In various embodiments, the method 100 includes performing quality control of the input data (e.g., provided by users). For example and without limitation, the system involved in the method 100 can determine the condition of the input data, and provide a message (e.g., it is not possible to complete a job due to the poor condition of the input data) to the user. In another example, the user can determine the condition of the input data based on an example file including all input parameters, as described above. In various embodiments, a condition of data is determined based on factors such as accuracy, completeness, consistency, reliability and/or whether the data is up to date.

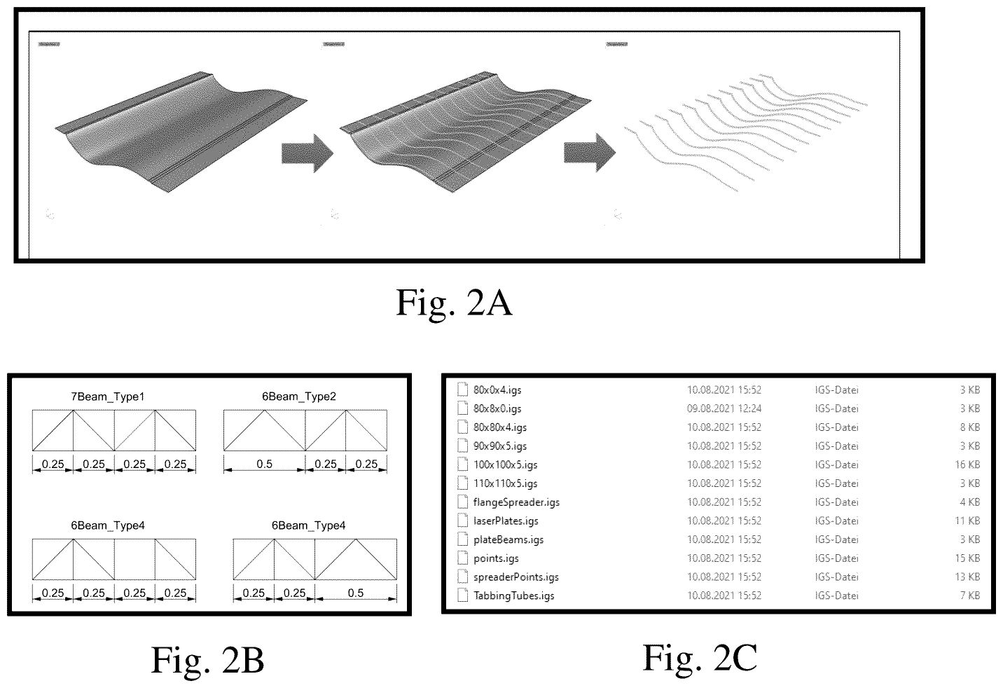

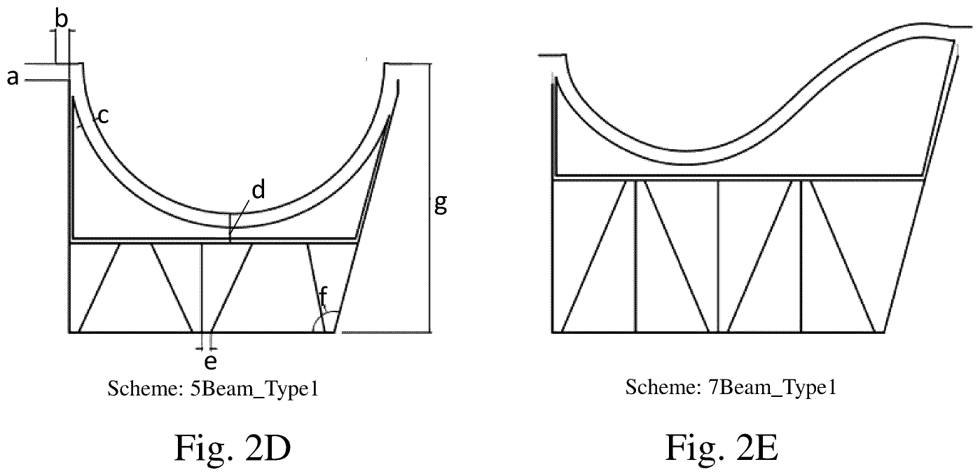

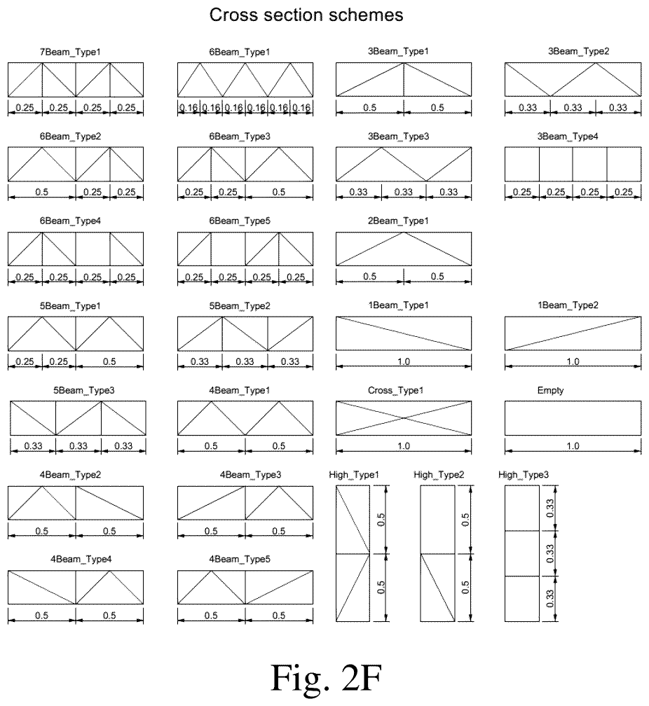

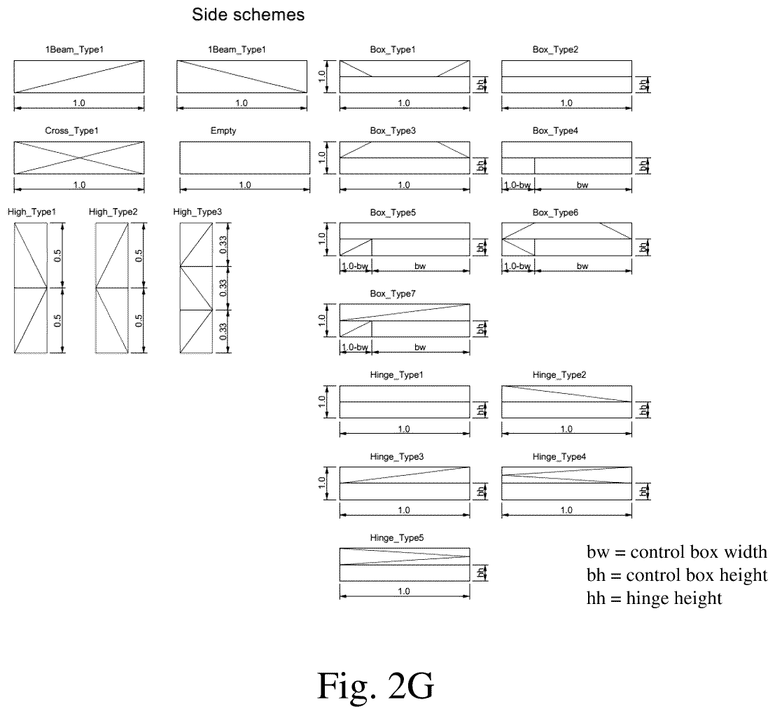

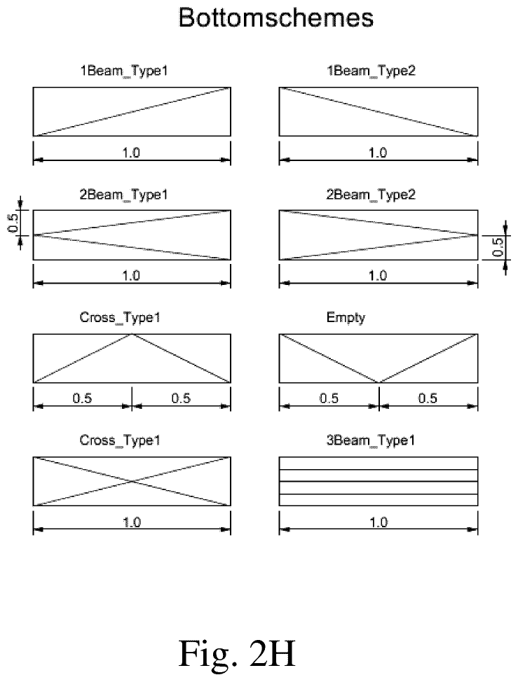

With continued reference to FIG. 1, method 100 includes, at step 115, receiving a design scheme. After a short computing time the mold frame generator (MFG) may ask the user/designer to select one or more design schemes (e.g., cross section schemes) to be used for the framework. The distance between these sections can be predefined in the parameter list, an example of which may be seen represented in FIGS. 2A-2C. The design schemes that are selectable by one or more users or receivable by the method described herein may include pictorial representations of the design scheme as seen in FIGS. 2A-2C. One or more users may select the design scheme based on any other element of data as described herein such as the at least on input parameter and the mold surface geometry. The design scheme may be associated with an intended product to be manufactured (e.g. particular wind turbine blade size/shape/contour/weight/etc.), such as a stronger mold frame for heavier parts or a more flexible mold frame for parts requiring flexibility of a varying degree. The user is now asked to choose from a large variety of schemes which will automatically be scaled according to the provided parameters and the given contour of the mold surface. The schemes can be chosen for the cross sections and the adjacent side and bottom connections. One or more users can choose what beam scheme they desire out of a large variety of schemes according to his experience. The one or more users may create beam layout schemes based on one or more parameters or one or more stored schemes, if needed. If the one or more users wants to optimize the frame according to a finite element analysis (FEA), the one or more users can rerun the program with slightly changed schemes. The criteria for choosing the beam type is handled by the user. The user can choose the beam type according to the local standards and availabilities, for example by country, region or another limiting factor like purchasing, operations or the like. For example, ANSI or ISO standard profiles may be selected. The one or more users can define the beams the user would like to use in the scheme, for example by cross section. An exemplary embodiment is shown in FIGS. 2A-2C. FIG. 2A refers to a mold surface that provides input data. FIG. 2B refers to example design schemes. FIG. 2C refers to example output. Additional exemplary embodiments are shown in FIGS. 2D-2H, including various cross section schemes (FIGS. 2D-2E), side schemes (FIGS. 2F and 2G), and bottom schemes (FIG. 2H).

In various embodiments, particular parameters are needed for particular schemes. These parameters can be provided by the user. The user may be informed by a program of the system if these parameters are not provided. If these parameters are provided but the scheme is not selected, the parameters may not be selected. For each cross section, the user can define the scheme. Accordingly, more than one scheme (e.g., one scheme as shown in FIG. 2D and another scheme as shown in FIG. 2E) are possible for an output model. As shown in FIGS. 2D and 2E, these parameters may represent one or more distances, thicknesses, slopes, or any other suitable parameters in schemes (e.g., cross section schemes). These parameters can be associated with a frame and/or a mold in the scheme, such as a distance between the frame and the mold flange (e.g., “a” and/or “b” in FIG. 2D), a mold shell thickness (e.g., “c” in FIG. 2D), a distance between the mold surface and the frame (e.g., “d” in FIG. 2D), a distance between metal tubes (e.g., “e” in FIG. 2D), a slope of a mold surface (e.g., “f” in FIG. 2D), and/or a distance from a mold surface to a ground level (e.g., “g” in FIG. 2D). With continued reference to FIG. 1, method 100 includes, at step 115, outputting a first plurality of files including at least one line model wherein the line model represents a generated framework. The framework can be used for wind turbine blade mold. The framework can be used in other applications (e.g., molds used in aerospace, automotive, or ship building). The first plurality of output files may be a collection of Initial Graphics Exchange Specification files (IGES-files). These files can represent the generated framework as a line model. The one or more files may represent one or more parts of the generated framework, in embodiments. For example and without limitation the one or more files may be associated with a profile type such as structural steel shape or beam type. Every profile type may be represented by its own IGES-file and contain all belonging beams represented by a line. In some embodiments, one or more laser cut metal sheets can also be created by the MFG. These are also exported as IGES-file and contain the border line of the metal sheet area. An exemplary embodiment is shown in FIG. 3. The mold frame generator creates two different sets of output files according to the provided input files.

With continued reference to FIG. 1, method 100 includes, at step 115, a second plurality of files including at least one element of geometry data in text form. The second plurality of files includes at least one element of data representing lines, start points, end points, and orientation of a portion of the metal frame. The second set of output files is a collection of JavaScript Object Notation files (JSON files). JSON files may be an interchange file format that uses human-readable text. At least one of these files contains the geometry data like points, lines with start and end point and the profile information as well as the orientation, and all information for the laser cut metal sheets as border lines and thickness. The other files may contain meta information. Meta information may include materials, costs, bill of materials, material properties, or the like. Meta information may include contact information of one or more suppliers associated with generated framework and/or model. In various embodiments, meta information may be estimated weight of the framework. In various embodiments, meta information may be rough price estimates from one or more suppliers based on information such as the weight of the framework (i.e., how much material is required). The meta information may be utilized to do any number of calculations automatically or at the command of the one or more users. The meta information may be used to estimate manufacturing capabilities at any number of suppliers or in-house.

With continued reference to FIG. 1, the IGES-files can now be reviewed by the one or more users and/or designers and an iterative optimization loop can be started. If the designer is not satisfied with the line model the MFG created, it can be re-run with modified input parameter and scheme information. After a positive review of the model, it can be used for finite element analyses (FEA).

With continued reference to FIG. 1, method 100 includes, at step 120, performing finite element analysis of the line model and at least one element of geometry data. The first plurality of files and the second plurality of files may be manipulated, processed or combined to define one or more geometrical bodies including mechanical and/or material properties associated therewith. For the purposes of this disclosure, “finite element analysis (FEA)” is a method for numerically predicting how a body reacts to forces, vibration, heat, fluid flow, and other physical phenomenon. For example and without limitation, FEA may be performed on a beam model with included coupling methods and forces applied there-along to predict the bending moment, torsion, shear, and other resultant forces. FEA may be performed on a generated framework or portion thereof, structural analysis may be performed and visualized, such as a color coordinated resultant model of the framework including a chart that associates forces/moments intensity with a color. FEA may include generation of one or more meshes conforming to the one or more bodies. These meshes may be the same or similar to any mesh generated in this method including but not limited to the mesh that may be generated from the point cloud of the mold surface.

According to the results from the FEA the at least one input parameter can be modified again, and the method or any portion thereof can be re-run. With this iterative approach the framework can be optimized during the design phase.

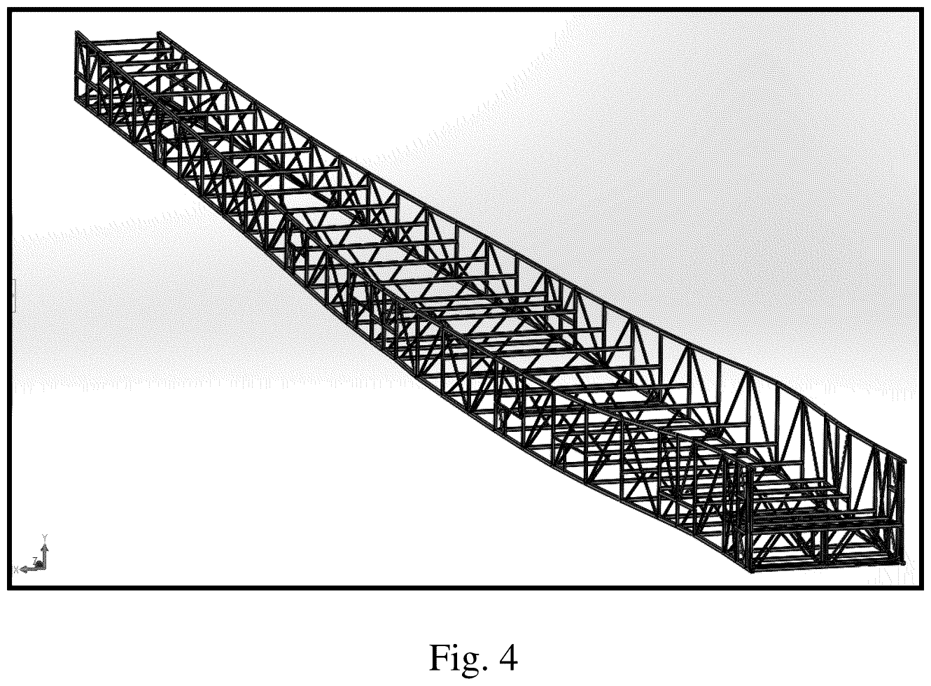

With continued reference to FIG. 1, method 100 includes, at step 125, outputting a full frame model. After optimization of the framework the second set of output files can be read by the second part of the software tool. The second part is a Macro which is integrated into a parametric computer aided design (CAD) program. The Macro reads the JSON-files and creates a full three-dimensional solid framework according to the prior created files, said 3D solid framework is shown in FIG. 4.

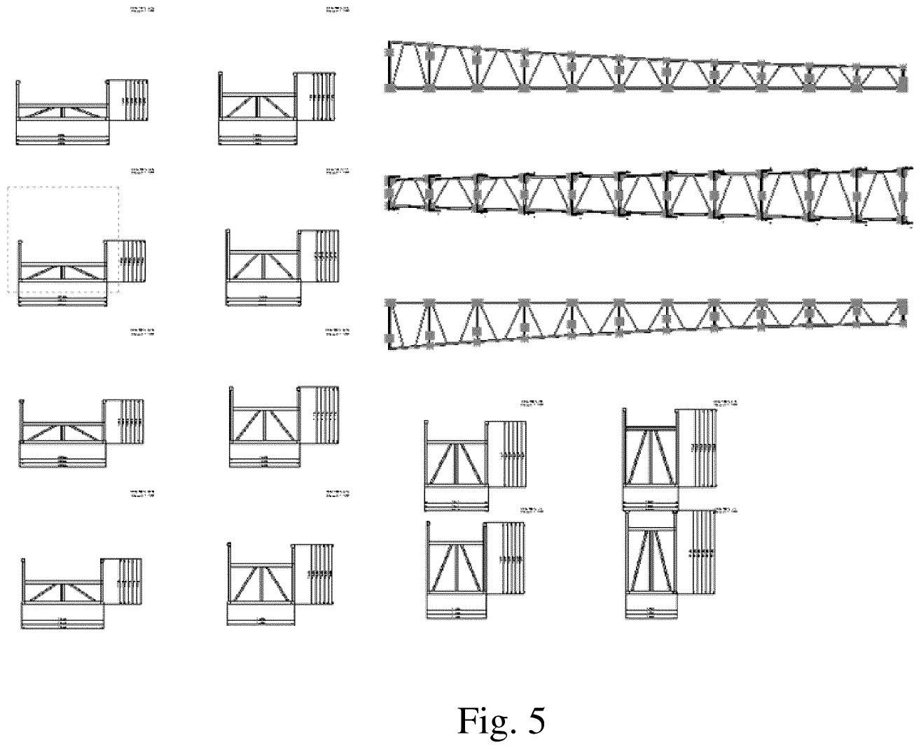

With continued reference to FIG. 1, method 100 includes, at step 130, outputting at least one technical drawing of the full frame model. After finishing the full solid model, the macro creates manufacturing drawings from the framework including total views, cross-sections, and cutting list or bill of material, which can be used for actual frame manufacturing, and to solicit quotes from suppliers. An exemplary embodiment is shown in FIG. 5. The at least one technical drawing may include the same or similar meta information, geometrical information, supplier or contractor information, revision history, and the like. The at least one technical drawing may include all the information required to manufacture the metal framework generated by the method described herein. The at least on technical drawing may include embedded CAD and/or CAM data to interface with one or more automated manufacturing processes such as 6-axis milling machines, industrial robots, conveyors, lifters, electric discharge machining (EDM) systems, additive manufacturing systems, and the like.

It is understood in advance that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

In general, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models, as described further below.

In general, the characteristics of a cloud model can include on-demand self-service, broad network access, resource pooling, rapid elasticity, and/or measured service.

In various embodiments, the on-demand self-service indicates that a cloud consumer can unilaterally provision computing capabilities, such as server time and network storage, as needed automatically without requiring human interaction with the service's provider.

In various embodiments, the broad network access indicates that capabilities are available over a network and accessed through standard mechanisms that promote use by heterogeneous thin or thick client platforms (e.g., mobile phones, laptops, and PDAs).

In various embodiments, the resource pooling indicates that a provider's computing resources are pooled to serve multiple consumers using a multi-tenant model, with different physical and virtual resources dynamically assigned and reassigned according to demand. There can be a sense of location independence in that the consumer generally has no control or knowledge over the exact location of the provided resources but may be able to specify location at a higher level of abstraction (e.g., country, state, or datacenter).

In various embodiments, the rapid elasticity indicates that capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

In various embodiments, the measured service indicates that cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

In general, the service models can include Software as a Service (SaaS), Platform as a Service (PaaS), and/or Infrastructure as a Service (IaaS).

In various embodiments, the Software as a Service (SaaS) indicates the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

In various embodiments, the Platform as a Service (PaaS) indicates the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

In various embodiments, the Infrastructure as a Service (IaaS) indicates the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

In general, the deployment models can include private cloud, community cloud, public cloud, and/or hybrid cloud.

In various embodiments, the private cloud indicates the cloud infrastructure is operated solely for an organization. It may be managed by the organization or a third party and may exist on-premises or off-premises.

In various embodiments, the community cloud indicates the cloud infrastructure is shared by several organizations and supports a specific community that has shared concerns (e.g., mission, security requirements, policy, and compliance considerations). It may be managed by the organizations or a third party and may exist on-premises or off-premises.

In various embodiments, the public cloud indicates the cloud infrastructure is made available to the general public or a large industry group and is owned by an organization selling cloud services.

In various embodiments, the hybrid cloud indicates the cloud infrastructure is a composition of two or more clouds (private, community, or public) that remain unique entities but are bound together by standardized or proprietary technology that enables data and application portability (e.g., cloud bursting for load-balancing between clouds).

In general, a cloud computing environment is service oriented with a focus on statelessness, low coupling, modularity, and semantic interoperability. At the heart of cloud computing is an infrastructure comprising a network of interconnected nodes.

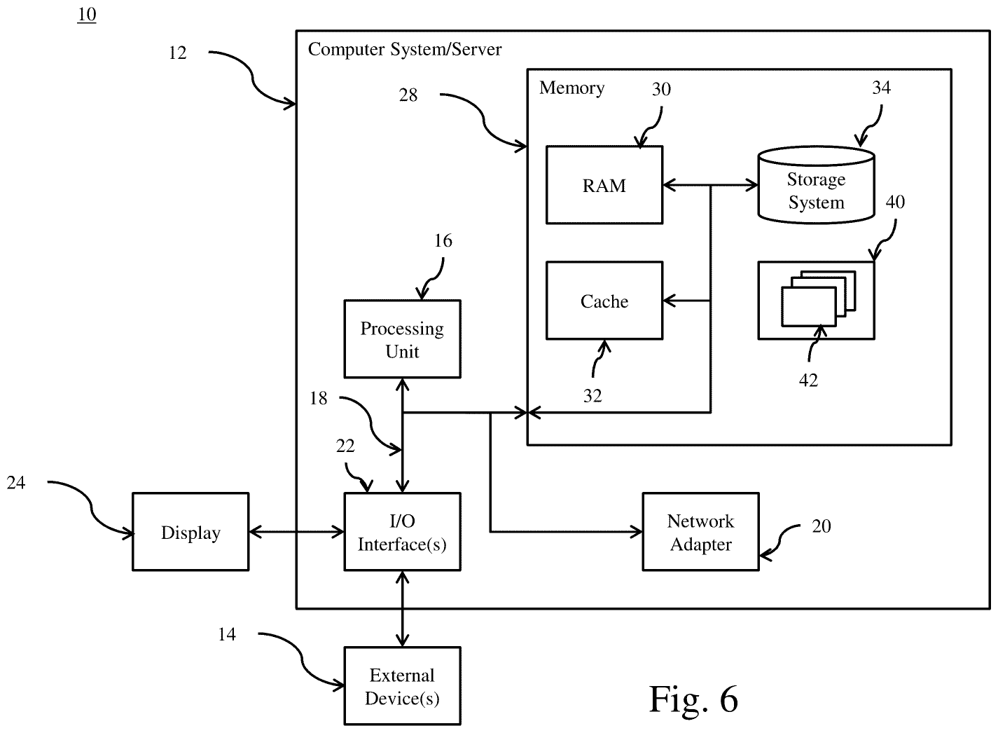

Referring now to FIG. 6, a schematic of an example of a cloud computing node is shown. Cloud computing node 10 is only one example of a suitable cloud computing node and is not intended to suggest any limitation as to the scope of use or functionality of embodiments described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the disclosed subject matter is described herein in terms of certain preferred embodiments, those skilled in the art will recognize that various modifications and improvements may be made to the disclosed subject matter without departing from the scope thereof. Moreover, although individual features of one embodiment of the disclosed subject matter may be discussed herein or shown in the drawings of the one embodiment and not in other embodiments, it should be apparent that individual features of one embodiment may be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

1. A method for manufacturing a metal frame support of a wind turbine blade mold, the method comprising:
receiving a wind turbine blade mold surface comprising a three-dimensional geometry file;
receiving at least one input parameter;
receiving a design scheme;
outputting a first plurality of files comprising at least one line model wherein the line model represents a generated framework;
outputting a second plurality of files comprising at least one element of geometry data in text form;
performing finite element analysis of the line model and at least one element of geometry data;
outputting a full frame model; and
outputting at least one technical drawing of the full frame model.

2. The method of claim 1, wherein the at least one input parameter comprises one of mold shell thickness, distance from the mold surface to a ground level, and structural tubing.

3. The method of claim 1, wherein the design scheme is scaled automatically to the at least one input parameter and the mold surface.

4. The method of claim 1, wherein the design scheme comprises a cross section of a metal frame.

5. The method of claim 1, wherein the design scheme comprises an adjacent side connection and a bottom connection.

6. The method of claim 1, wherein the design scheme is selected from a plurality of design schemes.

7. The method of claim 1, wherein the second plurality of files comprises at least one element of data representing lines, start points, end points, and orientation of a portion of the metal frame.

8. The method of claim 1, further comprising:
performing quality control with the at least one input parameter.

9. The method of claim 1, further comprising:
converting the mold surface to a point cloud.

10. The method of claim 9, wherein the point cloud comprises 100 points per 100 millimeters.

11. A system for manufacturing a metal frame support of a wind turbine blade mold, the system comprising:
a first module for receiving input data comprising at least a wind turbine blade mold surface comprising a three-dimensional geometry file, at least one input parameter, and a design scheme;
a second module for generating a first plurality of files comprising at least one line model wherein the line model represents a generated framework and a second plurality of files comprising at least one element of geometry data in text form; and
a third module for performing finite element analysis of the line model and at least one element of geometry data, outputting a full frame model, and outputting at least one technical drawing of the full frame model.

12. The system of claim 11, wherein the at least one input parameter comprises one of mold shell thickness, distance from the mold surface to a ground level, and structural tubing.

13. The system of claim 11, wherein the design scheme is scaled automatically to the at least one input parameter and the mold surface.

14. The system of claim 11, wherein the design scheme comprises a cross section of a metal frame.

15. The system of claim 11, wherein the design scheme comprises an adjacent side connection and a bottom connection.

16. The system of claim 11, wherein the design scheme is selected from a plurality of design schemes.

17. The system of claim 11, wherein the second plurality of files comprises at least one element of data representing lines, start points, end points, and orientation of a portion of the metal frame.

18. The system of claim 11, wherein quality control is performed with the at least one input parameter.

19. The method of claim 11, wherein the mold surface to a point cloud.

20. The method of claim 19, wherein the point cloud comprises 100 points per 100 millimeters.
